(19) United States
(12) Patent Application Publication
(10) Pub. No.: US 2011/0177244 A1
(43) Pub. Date: Jul. 21, 2011

(54) SOUND-DEADENING INSULATING MATERIALS WITH HIGH FIRE-RESISTANCE TIME

(75) Inventors: Jan-Gerd Hansel, Bergisch Gladbach (DE); Otto Mauerer, Leichlingen (DE)

(73) Assignee: LANXESS DEUTSCHLAND GMBH, Leverkusen (DE)

(21) Appl. No.: 13/074,181

(22) Filed: Mar. 29, 2011

Related U.S. Application Data
(62) Division of application No. 12/388,706, filed on Feb. 19, 2009.

(30) Foreign Application Priority Data
Feb. 28, 2008 (DE) 10 2008 011 562.2

(51) Int. Cl. B05D 5/00; B29C 67/20

(52) U.S. Cl. 427/243; 264/46.4

(57) ABSTRACT

The present invention relates to a process of producing flame retarding, sound deadening insulating materials and their use.

This application is a divisional of U.S. patent application Ser. No. 12/388,706 filed Feb. 19, 2009, pending, entitled “Sound-deadening insulating materials with high fire-resistance time”, which claims priority to DE10 2008 011 562.2, the contents of which are hereby incorporated by reference, in their entirety.

The present invention relates to flame-retarding, sound-deadening insulating materials or foam combinations, to a process for their production, and also to their use.

### BACKGROUND OF THE INVENTION

Foams based on synthetic polymers have a wide variety of uses as thermally insulating materials. Examples are foams composed of polyurethane, polyisocyanurate, polystyrene, polyvinyl chloride, polyethylene, and polypropylene. Foam-based thermally insulating materials are preferably produced in the form of rigid, dimensionally stable foams, known as rigid foams. The mechanical stability thus obtained is advantageous for engineering purposes. Further advantages of these foams are low density, low thermal conductivity, good processability, and low price. A disadvantage in comparison with mineral-based insulating materials is their inherent flammability. There are therefore many known methods which can be used to reduce the flammability of foams. An example of an overview of foams and processes for their production is found in Heinz Weber, Isidoor de Grave, Eckhart Röhrl: “Foamed Plastics”, Ullmann's Encyclopedia of Industrial Chemistry, Electronic Release, 7th ed., 2005 Wiley-VCH Verlag GmbH & Co. KGaA, Weinheim 10.1002/14356007.a11_{—}435.

Foams can absorb sound and are therefore used for sound-deadening. It is known that flexible, highly filled, elastic foams, known as flexible foams, provide particularly good sound-deadening. In contrast, rigid foams are not very suitable for sound-deadening.

There are many known foam applications which require simultaneous thermal insulation and sound absorption. By way of example, there is a need for materials which reduce the amount of noise produced in the engine compartment of an automobile and simultaneously can avoid uncontrolled heating of the passenger compartment by the heat dissipated from the engine. In refrigerator design, too, the intention is firstly to provide sound-deadening of the noise from running of the compressor and secondly to retain low temperature. In the construction industry, there is a requirement for design elements which are equally effective in meeting modern demands for heat-saving and in providing good acoustics in buildings and protection from noise. In all of the examples mentioned, the materials have to comply with relevant fire-protection regulations. The demands placed upon the materials used here are not only a particular level of fire performance or a particular level of flame retardancy but also a particular level of fire-resistance time. The fire-resistance time is the period of time for which, in the event of a fire, a product can resist the effects of the fire, in particular the heat produced, without loss of function.

If a foam to be used as engineering material then has to provide sound-deadening and thermal insulation simultaneously, a compromise necessarily has to be found between the sound-absorbent properties of a flexible foam and the engineering advantages of a rigid foam. A combination of different materials is therefore often used.

EP 0 056 267 A1 describes a component which is based on a flame-retardant polyurethane foam and for which good thermally insulating properties and good acoustic insulation properties are claimed.

DE 10 2005 049 570 B3 discloses a sound-absorbent material which has a surface covering of a flame-retardant powder, of a flame-retardant solution, or of a flame-retardant coating, and which has been covered with a foil transparent to sound.

DE 29 00 157 A1 describes polystyrene foam sheets and polyurethane foam sheets, which have cavities at their surfaces, and which have been coated with a flame retardant preparation. There is no mention of thermal insulation properties and acoustic insulation properties.

U.S. Pat. No. 3,934,066 discloses laminates composed of a foam, of a barrier layer, of an intumescent layer, and of a flexible protective layer, these being intended to be suitable for thermal insulation and acoustic insulation.

EP 0 107 935 A1, U.S. Pat. No. 4,168,347, and U.S. Pat. No. 4,265,963 describe, as insulating material, suitable polystyrene foam sheets with an intumescent coating.

U.S. Pat. No. 4,530,877 discloses an insulating element which is composed of a first external skin, of an intumescent layer, of a foam layer, and of a second external skin. The external skins are preferably composed of steel sheet.

EP 0 707 948 A1 describes thermally and acoustically insulating composite elements composed of an extruded polystyrene foam layer, of an adhesive layer, and of a gypsum-plasterboard sheet.

A disadvantage of the insulating materials of the prior art is their complex structure composed of many layers, or their complicated production. These insulating materials also often fail to meet the current fire-protection requirements, in particular with respect to fire-resistance time or smoke toxicity, which by way of example can be adversely affected by halogen-containing flame retardants. Finally, acoustic properties are unsatisfactory, in particular sound absorption.

It was therefore an object of the present invention to provide insulating materials which are simultaneously sound-deadening, thermally insulating, and particularly flame-retardant, and which are easy to produce because they have a simple structure. Surprisingly, it has been found that this object can be achieved if a specific intumescent layer is provided to known foams.

### SUMMARY OF THE INVENTION

The present invention provides insulating materials composed at least of one insulation layer and of one intumescent layer wherein

A) the insulation layer is composed of a synthetic foam,

B) the intumescent layer is composed of a polyurethane foam based on phosphorus-containing polyols, and

C) the thickness of the intumescent layer is from 2 to 98% of the thickness of the entire insulating material

For clarity, it should be noted that the scope of the invention encompasses any desired combination of all of the definitions and parameters listed below in general terms or mentioned in preferred ranges.

### DETAILED DESCRIPTION OF THE INVENTION

The synthetic foam involves a foam composed of polyurethane, polyisocyanurate, polyalkylene, polystyrene, polyvinyl chloride (PVC), phenol-formaldehyde resin, urea-formaldehyde resin, melamine-formaldehyde resin, silicone, epoxy resin, polyimide, polyester, polyamide, polycarbonate, or polysulfone.

Polyalkylenes preferred in the invention are low-density polyethylenes (LDPE), high-density polyethylene (HDPE), linear low-density polyethylene (LLDPE), or polypropylene.

Polystyrenes preferred in the invention are expandable polystyrene (EPS), or extruded polystyrene (XPS).

Polyvinyl chlorides preferred in the invention are rigid PVC or flexible PVC.

In one particularly preferred embodiment of the invention, the synthetic foam involves a foam composed of polyurethane, polyisocyanurate, expandable polystyrene (EPS), or extruded polystyrene (XPS).

The synthetic foam can be a flame-retardant foam. Its flame retardancy can, for example, be based on the use of flame retardants during its production. Examples of flame retardants that can be present in the synthetic foam are the chlorine-, bromine-, nitrogen-, phosphorus-, antimony-, aluminum-, and/or magnesium-containing substances known for this purpose.

The intumescent layer is composed of a polyurethane foam based on phosphorus-containing polyols. These polyurethane foams and the raw materials and production processes needed for their production are known, for example from EP 0 116 846 A1, EP 0 218 080 A1, or EP 0 400 402 A1.

The phosphorus-containing polyols are low-molecular-weight or oligomeric esters of phosphoric acid, of phosphonic acid, of phosphorous acid, or of phosphinic acid, and bear at least two hydroxy groups per molecule.

In one preferred embodiment of the invention, the phosphorus-containing polyols involve substances of the general formula (I)

(R¹—O)₂P(═O)—CH₂—N(CHR²—CHR³—OH)₂ (I)

in which

R¹ is C₁-C₄-alkyl, if appropriate substituted by a hydroxy group, and

R² and R³, independently of one another, are H or methyl.

The insulation layer and intumescent layer can, independently of one another, be produced in the form of flexible foam or else in the form of rigid foam. The insulating material can thus be adapted to many applications.

In one preferred embodiment, the insulation layer involves a rigid foam and the intumescent layer involves a flexible foam. In another preferred embodiment of the invention, the insulation layer involves a rigid foam and the intumescent layer likewise involves a rigid foam or a semirigid foam.

The insulating materials can include further components, alongside the two layers essential to the invention. In particular, there can be multiple bonding of the two layers mentioned. For example, the insulating material can be composed of an intumescent layer—insulation layer—intumescent layer composite or of an insulation layer—intumescent layer—insulation layer composite. It is also possible, for example, that foils, textiles, nonwovens, mats, and the like are present, composed of metals, of plastics, of wood, or of other plant-based materials. Layers composed of mineral-based materials can also be present, preference being given to cement or gypsum plaster.

There is a secure and water-resistant bond between the insulation layer and intumescent layer of the insulating materials of the invention, at the shared area of contact. For the purposes of the present invention, the thickness of the entire insulating material is defined as the external dimension of any desired molding composed of an insulating material of the invention, measured in essence perpendicularly with respect to the area of contact. This thickness of the entire insulating material can vary within wide limits, as a function of application. The thickness can therefore be less than 1 mm or else more than 1000 mm. The thickness of the entire insulating material is preferably from 1 mm to 1000 mm.

Since the two components of the insulating materials of the invention are composed of foams, there are no limits placed upon their shaping. The insulating materials can be produced in the form of insulating-material elements, for example in the form of blocks or sheets. The intumescent layer here can have been attached in such a way that it covers only one side of the block or of the sheet, or else any desired number of sides. However, the insulating-material elements can also be formed in the shape of a cylindrical jacket or the type of shell useful for the insulation of pipes. The insulating material can also be produced in the form of a profile in order, for example, to seal joints. However, in particular, the shape of the insulating material can also adapt to any desired shape prescribed by the application, for example to a cavity in automobile bodywork.

The two layers of the insulating materials can be produced by processes known for polyurethane foams and can be bonded to one another in any desired manner.

By way of example, the layers can be produced by the single-stage process in which the components of the mixing specification are mixed in accordance with the mixing specification and then caused to react, as described in Kunststoff Handbuch [Plastics Handbook], vol. 7, 3rd edn., 1993, Hanser Verlag, page 140. A rigid foam functioning as insulation layer can, for example, be manufactured continuously on a double-conveyor-belt system as described in Kunststoff Handbuch [Plastics Handbook], vol. 7, 3rd edn., 1993, Hanser Verlag, pages 272-277. Pages 272 to 273 in that publication describe a continuous process for the production of insulation foams on a double-conveyor system, and pages 274-277 describe batch production variants. Sheets thus produced can then be coated with an intumescent layer. The intumescent layer can be produced in the same way as the insulation layer.

However, the process described below is particularly advantageous, integrating production and bonding.

The present invention also provides a process for the production of insulating materials, which are composed at least of one insulation layer composed of a synthetic foam and of one intumescent layer composed of a polyurethane foam based on phosphorus-containing polyols, which comprises

A) producing, by known processes, a molding, profile, or similar semifinished product composed of the synthetic foam,

B) producing a liquid reaction mixture via mixing of the raw materials necessary for the production of the polyurethane foam based on phosphorus-containing polyols, and

C) applying this liquid reaction mixture to the relevant surfaces of the semifinished product, where it foams and hardens.

All of the three steps of the process can be carried out batchwise or continuously. The expression “by known processes” relates to the production processes known for synthetic foams, depending on the nature of the foam. The foams to be used in the invention have been listed above. If the synthetic foam involves polyurethane foam, corresponding processes have likewise been mentioned above. If polyurethane foam is not involved, examples of known processes for the various types are found in H. Weber, J. de Grave, E. Röhrl: “Foamed Plastics”, Ullmann's Encyclopedia of Industrial Chemistry, Electronic Release, 7th edn. Wiley-VCH, Weinheim 2005.

The second step B) of the process is preferably carried out at from 5 to 50° C. It is particularly preferably carried out at from 15 to 35° C. The mixing can preferably be carried out in a conveying and mixing head which is conventional in polyurethane production.

The third step C) of the process is preferably carried out at from 5 to 150° C. It is particularly preferably carried out at from 15 to 90° C. It is preferably executed by the foam-molding method.

In this, the molding composed of the synthetic foam is introduced into a mold. The liquid reaction mixture is applied to the molding in the mold, whose temperature can have been controlled to from 5 to 150° C., and the mold is then closed. On foaming and hardening of the reaction mixture, the remaining volume defined by the mold and by the molding present is entirely filled by the intumescent layer.

The process of the invention is particularly suitable for the production of insulating-material elements.

For the purposes of this invention, the term insulating-material elements is used for a product comprising an insulating material and prefabricated in standardized shapes and sizes, thus permitting its use with precise fit for a particular application, and with easy handling. By way of example, insulating-material elements are needed in the form of sheets in the construction sector.

The insulating-material elements produced from the insulating material of the invention and, respectively, by the process of the invention feature integration of noise prevention, thermal insulation, and fire protection in one construction element. There is then no need for separate installation, for example of fire-protection elements and noise-prevention elements. The elements are self-supporting, and this means that there is no need for a component with solely structural function that does not contribute to the desired effect (support component, peripheral component, load-bearing component). This provides substantial advantages in the application, since the insulating-material elements have very low weight and are easy to cut. Since both layers of the insulating-material elements can be composed of flexible foam, they are capable of compensating unevenness at the site of use (for example masonry, screed).

The process of the invention ensures that insulation layer and intumescent layer have been bonded to one another in a secure and water-resistant manner, without any need of additional adhesives for this purpose.

Finally, the present invention provides the use of insulating materials which are at least composed of one insulation layer composed of a synthetic foam and of one intumescent layer composed of a polyurethane foam based on phosphorus-containing polyols, and which are used for thermal insulation or for sound-deadening. In one preferred embodiment of the invention, the insulating materials are used for purposes which demand thermal insulation and sound-deadening simultaneously. In one particularly preferred embodiment, the insulating materials have a high fire-resistance time of more than 30 minutes, and are used for thermal insulation and sound-deadening. Examples of these uses are found in vehicle construction, in mechanical engineering, in container construction, and in plant construction, in the internal fitting-out of residential, commercial, and industrial buildings, in the insulation of pipelines, or in the production of refrigerators and freezers.

The invention is illustrated in more detail by the examples below, which are not intended to bring about any restriction of the invention.

It will be understood that the specification and examples are illustrative but not limitative of the present invention and that other embodiments within the spirit and scope of the invention will suggest themselves to those skilled in the art.

### EXAMPLES

Unless otherwise stated, all parts and percentages are based on weight.

### Starting Materials for Production of the Insulating Materials

The insulation layer used comprised an insulation foam sheet composed of commercially available rigid polyurethane foam with density of 30 kg/m³, rendered flame-retardant to

DIN 4102 B2. The starting materials for the production of the intumescent layer have been described in detail in EP 0 217 080 A1.

### Production of the Insulating Materials

### Example 1

Insulating material composed of rigid polyurethane foam sheet coated on one side with flexible intumescent layer

A foam element of dimensions about 500×500×60 mm was sawn out of a commercially available rigid polyurethane foam insulation sheet of thickness 60 mm. This foam element was inserted into a mold with movable mold cover and with internal dimension of about 500×500×66 mm. A reaction mixture corresponding to example 15 of EP 0 217 080 A1 was prepared. The resultant, liquid reaction mixture was poured into the mold, and the mold cover was securely sealed. After a demolding time of about 10 minutes, a molding with flexible intumescent layer was obtained. A particular feature of this was that the intumescent layer had excellent adhesion on the backing material.

### Example 2

Insulating material composed of rigid polyurethane foam sheet coated on one side with rigid intumescent layer

The production of the insulating element described in example 1 was modified to use a reaction mixture corresponding to example 12 of EP 0 217 080 A1. The resultant molding had a rigid intumescent layer.

### Fire Testing and Test Results

To assess flame retardancy, the fire-resistance time of the insulating materials of examples 1 and 2, and also of the uncoated rigid polyurethane foam sheet as comparative example, was determined. For this, fire resistance was determined to DIN 4102-8 in the small test rig. In this test, two test specimens of identical structure are mounted as side walls of an oil burner. The dimensions are 500×500 mm. The oil burner is operated with about 13 kg of oil/h. The temperatures in the interior of the burner reach about 1000° C. The test specimens serve as periphery of the combustion chamber. The intumescent coating of the invention faces toward the fire and has unprotected exposure to the flames. There are five thermocouples attached to the external side of each test specimen, one precisely in the center and one approximately in the center of each quadrant. The total of 10 thermocouples is used to record the temperature increase on the external side during the entire test time. The temperature increase indicated with respect to the ambient temperature is not permitted to exceed 180° C. for each individual thermocouple, and 140° C. on average for all of the thermocouples.

Table 1 lists the results of this test.

TABLE 1
Test results for fire test

| | Example | | | |
|---|---|---|---|---|
| | Comparative | | | |
| | example | | Example 1 | Example 2 |
| | Description | | | |
| | | | rigid polyurethane | rigid polyurethane |
| | | | foam sheet coated | foam sheet coated |
| | | | on one side with | on one side with |
| | uncoated rigid | | from 8-10 mm | from 8-10 mm |
| | polyurethane | | thickness of flexible | thickness of rigid |
| | foam sheet | | material | material |
| Average | >30 | min* | 53.5 min | 46.5 min |
| temperature | | | | |
| >140° C. | | | | |
| Local | 24 | min | 58.5 min | 48.0 min |

temperature T
>180° C.

*An average temperature >140° C. was not reached during a test time of 30 min. The test was terminated after 30 min in this case, since >180° C. had already been reached locally.

### Evaluation

A decisive test criterion, in addition to penetration of fire through a sheet-like test specimen, is the increase of temperature on the side facing away from the fire. A feature of materials with high fire-resistance time is maximization of the time, from the start of exposure to the flame, for which this temperature does not exceed the defined limits. The material has to have maximum thermal-insulation effect, and must minimize any reduction of this thermal-insulation effect resulting from the action of the fire. The times in table 1 show that, by these criteria, the fire-resistance time of the insulating material of the invention, the thickness of whose intumescent layer was only about 8-10 mm, was considerably improved when compared with that of the uncoated rigid polyurethane sheet of the comparative example. As shown by the examples in table 1, the protective coating can take the form of rigid foam or of flexible foam. In each case, there is an improvement in fire-resistance time.

### Acoustic Testing and Test Results

To assess sound-deadening, the sound-absorption level was determined to DIN EN ISO 10534-2 on the insulating material of example 1, and also on the uncoated rigid polyurethane foam sheet as comparative example. For this, test specimens were positioned at one end of a test pipe. At the other end, there was a loudspeaker, which irradiated the specimen perpendicularly. Microphones which could determine acoustic pressure had been installed at two sites on the test pipe. The test result recorded was relative absorption of sound as a function of frequency. Table 2 lists the results of this test.

TABLE 2
Test results from acoustic testing

| | Example | |
|---|---|---|
| | Comparative example | Example 1 |
| | Description | |
| | uncoated rigid | rigid polyurethane |
| | polyurethane foam | foam sheet |
| | sheet | coated on one side |
| | Sound absorption | Sound absorption |
| Frequency [Hz] | of specimen | of specimen |
| 315 | −0.01 | 0.08 |
| 400 | 0.05 | 0.07 |
| 500 | 0.03 | 0.10 |
| 630 | 0.04 | 0.13 |
| 800 | 0.05 | 0.18 |
| 1000 | 0.06 | 0.23 |
| 1250 | 0.09 | 0.33 |
| 1600 | 0.21 | 0.53 |
| 2000 | 0.14 | 0.66 |
| 2500 | 0.12 | 0.82 |
| 3150 | 0.11 | 0.94 |
| 4000 | 0.15 | 0.91 |
| 5000 | 0.38 | 0.85 |

Evaluation

As shown by the test results from table 2, sound absorption and therefore sound-deadening of the insulating material of the invention is better at all frequencies than that of the uncoated rigid polyurethane foam sheet. The intumescent layer of thickness only from 8 to 10 mm on the insulating material accordingly not only provides markedly improved fire-resistance time but also leads to extensive absorption of sound, in particular at frequencies above 1600 Hz.

What is claimed is:

1. A process for the production of insulating materials, which are composed at least of one insulation layer composed of a synthetic foam and of one intumescent layer composed of a polyurethane foam based on phosphorus-containing polyols, comprising
A) producing, by known processes, a molding, profile, or similar semifinished product composed of the synthetic foam,
B) producing a liquid reaction mixture via mixing of the raw materials necessary for the production of the polyurethane foam based on phosphorus-containing polyols, and
C) applying this liquid reaction mixture to the relevant surfaces of the semifinished product, where it foams and hardens.

2. The process as claimed in claim 1, wherein step C) is executed by the foam-molding method.

3. The method of using insulating materials as claimed in claim 1 for thermal insulation or for sound-deadening.

4. The method of use as claimed in claim 3, wherein the insulating materials are used simultaneously for thermal insulation and for sound-deadening.

5. The method of use as claimed in claim 3, wherein the insulating materials are used in the form of insulating-material elements.
